(19) United States
(12) Patent Application Publication
(10) Pub. No.: US 2015/0073945 A1
(43) Pub. Date: Mar. 12, 2015

(54) METHODS AND SYSTEMS FOR FULFILLING ORDERS

(71) Applicant: Leigo NFC Holdings Pty Ltd, Hornsby (AU)

(72) Inventor: Robert Leigo, Hornsby (AU)

(21) Appl. No.: 14/391,647

(22) PCT Filed: Apr. 9, 2013
(86) PCT No.: PCT/AU2013/000363

§ 371 Date: Oct. 9, 2014

(30) Foreign Application Priority Data
Apr. 10, 2012 (AU) 2012901387

(51) Int. Cl. G06Q 30/06; H04W 4/00; G06Q 50/12

(52) U.S. Cl. CPC G06Q 30/0635; G06Q 50/12; H04W 4/008
USPC 705/26.81

(57) ABSTRACT

Methods and systems for processing orders for a product or service are described, the methods including the steps of: preparing order data which identifies at least one product or service; providing a user with a transmitting device for indicating their presence at a fulfillment location where the order can be fulfilled; and processing an order based on the order data.

### TECHNICAL FIELD

The present invention relates to methods and systems for fulfilling orders for products or services.

### BACKGROUND TO THE INVENTION

At a retail outlet, such as a coffee shop or fast food outlet, it is customary to place an order for food and beverages by way of dealing with a customer service operator in the store. The customer nominates items from the menu which they require, and these are manually entered into the in-store order fulfillment system by the operator. The customer may then be asked whether they participate in any loyalty scheme offered by the store and identify their membership number in the loyalty scheme. Then, loyalty rewards are applied to the customer's account and finally, a payment transaction is carried out.

The present invention seeks to provide improved methods and systems for placing and fulfilling orders for products and services.

### SUMMARY OF THE INVENTION

In a first aspect the present invention provides a method of processing an order for a product or service including the steps of: preparing order data which identifies at least one product or service; providing a user with a transmitting device for indicating their presence at a fulfillment location where the order can be fulfilled; and processing an order based on the order data.

The order may be at least partially processed prior to the user arriving at the fulfillment location.

The order data may further include data representative of a pricing arrangement associated with the order.

In a second aspect the present invention provides a system for processing an order for a product or service including: preparation means for preparing order data which identifies at least one product or service; and at least one transmitting device for indicating the presence of a user at a fulfillment location where the order can be fulfilled.

The at least one transmitting device may include a near field communication device.

The near field communication device may be a powered near field communication device.

The system may be embodied in a hand held device of the user.

The transmitting device may be further arranged to transmit payment data to facilitate payment for the order.

In a third aspect the present invention provides a system for processing an order for a product or service including: at least one receiving device for detecting the presence of a user at a fulfillment location where the order can be fulfilled; and processing means for processing an order based on the order data.

The receiving device may be a near field communication device.

In a fourth aspect the present invention provides a software program which is configured to cause a computing device to operate as a system according to either of the second or third aspects of the invention.

### BRIEF DESCRIPTION OF THE DRAWINGS

Embodiment of the invention will now be described, by way of example only, with reference to the accompanying drawings, in which:

FIG. 1 is a schematic representation of a system according to an embodiment of the invention; and

FIG. 2 illustrates steps of data transfer in the system of FIG. 1.

### DETAILED DESCRIPTION OF THE EMBODIMENTS

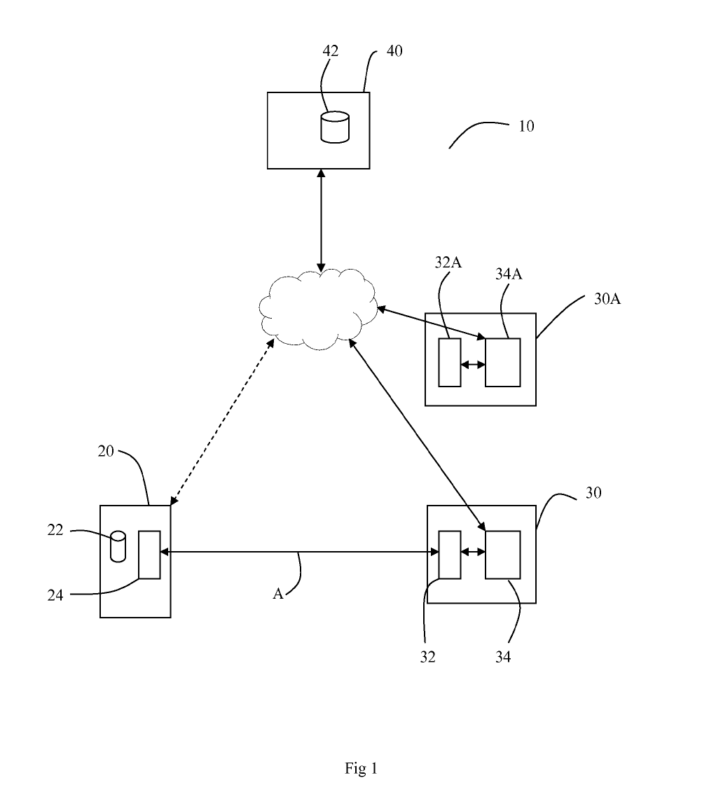

Referring to FIG. 1, a system 10 for processing orders is shown. The system will be explained in the context of being implemented in a chain of coffee shops, but has wider use as will be later explained.

A user computing device is shown in the form of mobile phone 20. Phone 20 is of the type of phone known as a “smartphone” and is configured with internet access and is able to download and run a selection of applications in a known manner. Phone 20 includes storage in the form of flash memory 22 and a Near Field Communication (NFC) chip 24.

In order to participate in system 10, the user initially downloads a software application which has been pre-configured to enable a user to indicate their selection of goods and services from a particular retailer. In the example of deployment of the system now being described, the software application allows the user to prepare, via a touch screen user interface, their usual order for one or more products from a coffee shop. These may include specific beverage choices, along with options available for that beverage (e.g. large black coffee with two sugars). When the user has confirmed their selection it is saved in storage 22 on mobile phone 20.

Two similar retail outlets 30, 30A are shown being retail outlets at different locations of a chain store of coffee shops. Each retail outlet includes an in-store NFC enabled POS (Point of Sale) device 32, 32A which is connected to their in store order fulfillment system 34, 34A.

POS devices 32, 32A are configured to repeatedly poll to detect the presence of NFC devices in their vicinity (typically less than 4 centimetres away). If a compatible device responds, then a data connection between the devices is initiated and they interact according to pre-configured instructions.

The NFC devices detected by the POS device include so-called “NFC tag” devices and powered NFC devices. NFC tag devices are passive tags typically incorporated into so-called contactless credit cards and do not have their own power supply. NFC tag devices include an induction coil to draw power from an RF field generated by the POS device. An antenna is associated with the tag to enable it to send and receive data. Powered NFC devices are typically found in mobile phones and use the on board power supply of the phone to enable them to send and receive data using a similar antenna. Some normally powered devices may also include an induction coil to enable them to work in a non-powered mode.

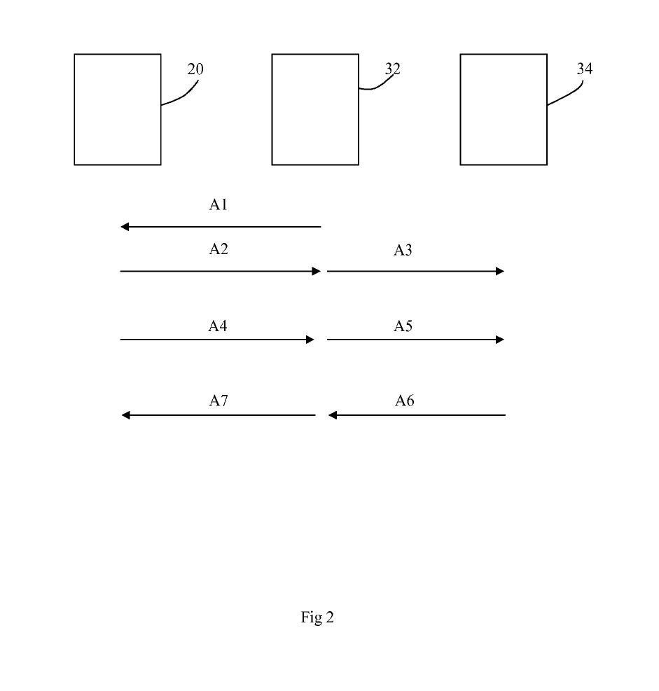

In the case of POS terminals 32, 32A, these are configured with software to establish a connection labelled A with the mobile phone 20 of the user and to interact with the mobile phone 20 in a manner as will now be explained with reference to FIG. 2.

Referring to FIG. 2, the user has arrived at the coffee shop and has brought their mobile phone 20 into close proximity to the NFC enabled POS reader 32 provided in store.

At step A1, POS device 32 polls for the presence of nearby NFC devices. The polling information includes data identifying the chain of stores and also data identifying the particular branch of the chain of stores e.g. “I am branch no. 123 of store XYZ”. The POS device sends this in the form of event codes. The polling information is received by mobile phone 20 and analysed to determine how to react to the received event codes and whether the phone holds any order information that is relevant to the particular POS terminal 32. The application that the user previously installed on their phone is registered to handle an event code sent by the POS terminal and controls the subsequent communication with the POS terminal.

At step A2 the user's application causes mobile phone 20 to indicate their presence in the store by responding to the polling signal and transmitting their order information along with details of any special pricing arrangement such as a voucher or coupon. The mobile phone also transmits data identifying the user. This may take the form of a field “NAME” to allow a user to be subsequently identified in store when their order is ready for collection or could identify them by reference to their membership number in a loyalty scheme operated by that store.

At step A3 the POS terminal transmits the order information along with details of the special pricing arrangement along with the information identifying the user for processing by the store's in house order fulfillment system 34. System 34 displays the order at relevant staff terminals in the retail store (such as on a display next to the barista, or kitchen staff)

At step A4 the user's mobile phone 20 transmits information authorising payment to be made by way of a credit card account linked to their NFC chip. In some instances the “payment” may be made by redeeming loyalty points or a voucher or coupon. Also, the payment may be made by deducting an amount of credit from a store account held by the customer. At step A5 this payment information is relayed back to the store's in-house system for redemption from the credit card company and is stored for accounts records keeping purposes.

At step A6 the in store system returns receipt information, along with details of any earned loyalty points or vouchers, to the POS terminal 32. This data is forwarded to user's phone 20 at step A7 by communication between the POS device and phone 20. The receipt may take the form of a barcode which can be viewed on screen.

Optionally, the in-store system may receive social media account information from the user's mobile phone during the transaction and may subsequently transmit data to the user's social media provider to indicate that the user has “checked in” at that particular venue. The user may elect to share such “check-in” data with their social media contacts.

Once the process outlined in FIG. 2 is completed, the user then awaits preparation of their coffee order. When their order is ready, they are called by name (obtained from the identifying information transmitted during the transaction) to collect their order in a traditional fashion.

Although the process above was explained with reference to processing an order in a coffee shop, the invention has wider application and can be used in a range of retail venues such as take-away restaurants, pharmacists or other venues to automatically place order information on behalf of users.

In some embodiments, (such as in a scenario involving food preparation) the user's device may be configured to transmit their order information ahead of their arrival at the retail outlet. The order data can be transmitted by way of their phone's internet connection to be received at web server (see item 40 in FIG. 1). This information is then relayed to the appropriate retail outlet for immediate or scheduled order fulfillment. Later, when the user arrives at the retail outlet, they bring their mobile phone into proximity of the NFC POS terminal in store and transmits information identifying that they have already submitted an order. Payment is thus made and the user will thus not have to wait for their order to be prepared.

The system has application in processing orders for medicines. In this embodiment, order information identifying required medicines is prepared by the user's doctor or other health professional and stored at a web-server in a secure manner. Upon visiting a pharmacy or other medicine dispensary, the user brings the NFC device into proximity with a reader. The information transmitted by their NFC device provides information to authorise the pharmacist's computing system to access the user's order information on-line.

The system has application in betting or gambling applications. A user can preconfigure their bet “order” in their mobile phone and place their bet by bringing their phone into the vicinity of a suitable reader in store at a betting or gambling venue. In such an application, the user could also collect their winnings by way of bringing their phone into the vicinity of the reader to effect a credit transaction to their linked account.

The system has application in a retail environment, such as a clothes retailer. A user enters a store. The user already has appropriate application installed on their phone. The application could include details such as clothing sizes and/or measurements particular to the user and previously entered or being derived from products previously purchased by the user. Clothing sizes could be brand specific. The user taps their phone against a clothing item (either a particular rack or perhaps swing/clothing label tag). The rack could have an active reader with peer to peer, swing tags would be passive. The phone registers the clothing item and could do any of the following:

a. add to ‘users cart’—they can then self checkout after selecting any other clothes

b. send a request to inventory to request the appropriate size be brought out to customer/and or display stock levels in that store (and perhaps other stores in chain). I.e. store doesn't have any size 34 pants in stock but a store at another location does.

c. In the case of a Men's suiting store, sizing details might be stored on the phone and rather than tapping against ‘clothing items’, the items may in fact be rolls of fabric, so a man could select suit fabrics.

Alternatively, a user could enter a store with no goods on display or approach a ‘kiosk’ with their phone and size/measurements stored. The kiosk could display a number of clothing items and the phone could send size details and this then be processed in store for those items to be brought out for the user to inspect them in order to make a purchasing decision.

The system has application in picking up or dropping off items such as drycleaning drop off/pick up. The user drops off drycleaning at an automated machine. The machine can obtain the user's personal details from their phone along with details of what items the user was dropping off Alternatively, the machine could read NFC tags on clothes items. A receipt order is provided to the customer.

The user returns to the drycleaning automated machine and taps their phone on an NFC reader which causes their order to be retrieved and returned to them. Payment could occur at ‘receipt’ phase or at the time of pickup.

Peer to peer communications between the reader and device may use a variety of protocols including but not limited to NDEF (Android Beam), or NFC Digital Protocol, Logical Link Control & NFC Simple NDEF Data Exchange Protocol (NFC Forum Standard) and any other standards that may emerge or the scheme set out in FIG. 2.

A combination of protocols could be used, for instance, the initial communication between a reader and a phone can be carried out using NFC connection, but Peer to Peer data could use more efficient data communication such as Bluetooth/Bluetooth LE or OTA/cloud.

In some embodiments, the user may participate in the scheme using a passive tag. For instance, a retail chain may give away or sell cards that are fitted with passive NFC tags which are encoded with data entitling the holder of the card to free products or preferential pricing as part of a marketing campaign.

In some embodiments, the user may have an NFC chip built into the cover of their phone, rather than being incorporated into the phone itself.

In the embodiment described above the user utilised a computing device with built in NFC chip in the form of a mobile phone. In other embodiments other types of computing device could be used such as a tablet, laptop, webpad or palm computing device.

In some embodiments the invention may utilise RFID tags and readers.

In some embodiments, the retail store may fit a passive NFC tag in the vicinity of their payment terminal. The user's phone polls for the presence of the passive tag which, when detected, indicates their presence in the store by initiating the placement of the order over another wireless protocol, such as Bluetooth or wife. This arrangement may also be used with an active reader, not just a passive tag.

In some embodiments, the details of the users order may be stored on a web server, 40, or in the computer system of the retail outlet. At the time of placing the order, the order details are then retrieved and processed.

Should the user ever wish to modify their order, then they can do this by modifying their preferences by way of their mobile phone application. A user could modify their order preference at the time of visiting the store should they wish to do so.

It can be seen that embodiments of the invention have at least one of the following advantages:
Users may place and pay for orders instantaneously reducing the likelihood of a queue building up.
Instantaneous order placement and payment removes a bottleneck at the retail outlet enabling them to increase production and revenue.
User does not need to explain order choices to a customer service operator thus avoiding risk of incorrect or inaccurate order placement by customer service operator.
User is automatically identified at time of placing order to increase participation in loyalty schemes.
A user can configure their regular order (such as their preferred morning coffee order) just once and this information is held for repeated use.
A customer visiting a foreign country can visit a branch of a multi-national chain of stores and place an order without the need to understand the menu written in the local language

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1-12. (canceled)

13. A method of processing an order for a product or service including the steps of:
receiving user prepared order data which has been prepared prior to the user attending at a fulfillment location where the order can be fulfilled, the order data identifying at least one product or service;
providing the user with a transmitting device, which the user may use to indicate their presence at the fulfillment location where the order can be fulfilled;
detecting the presence of the user at the fulfillment location; and
processing and fulfilling the order based on the order data in response to detecting the presence of the user at the fulfillment location.

14. A method according to claim 13, wherein the order is at least partially processed prior to the user arriving at the fulfillment location.

15. A method according to claim 13, wherein the order data further includes data representative of a pricing arrangement associated with the order.

16. A method according to claim 13, wherein the transmitting device includes a near field communication device.

17. A system for processing an order for a product or service including:
preparation means for allowing a user to prepare order data prior to attending at a fulfillment location, the order data identifies at least one product or service;
at least one transmitting device for indicating the presence of a user at a fulfillment location where the order can be fulfilled;
at least one receiving device for detecting the presence of the user at the fulfillment location; and
processing means for processing and fulfilling an order based on the order data in response to detecting the presence of the user at the fulfillment location.

18. A system according to claim 17, wherein the at least one transmitting device includes a near field communication device.

19. A system according to claim 18, wherein the near field communication device is a powered near field communication device.

20. A system according to claim 17, wherein the transmitting device is further arranged to transmit payment data to facilitate payment for the order.

21. A system according to claim 17, wherein the receiving device is a near field communication device.
